(19) United States
(12) Patent Application Publication
(10) Pub. No.: US 2012/0311266 A1
(43) Pub. Date: Dec. 6, 2012

(54) MULTIPROCESSOR AND IMAGE PROCESSING SYSTEM USING THE SAME

(75) Inventor: Hirokazu TAKATA, kanagawa (JP)

(73) Assignee: RENESAS ELECTRONICS CORPORATION, Kanagawa (JP)

(21) Appl. No.: 13/461,636

(22) Filed: May 1, 2012

(30) Foreign Application Priority Data
Jun. 2, 2011 (JP) 2011-124243

(51) Int. Cl. G06F 12/08

(52) U.S. Cl. 711/119; 711/E12.023

(57) ABSTRACT

To provide a multiprocessor capable of easily sharing data and buffering data to be transferred.

Each of a plurality of shared local memories is connected to two processors of a plurality of processor units, and the processor units and the shared local memories are connected in a ring. Consequently, it becomes possible to easily share data and buffer data to be transferred.

### CROSS-REFERENCE TO RELATED APPLICATION

The disclosure of Japanese Patent Application No. 2011-124243 filed on Jun. 2, 2011 including the specification, drawings and abstract is incorporated herein by reference in its entirety.

### BACKGROUND

The present invention relates to a technology of operating a plurality of processors in parallel and particularly, to a multiprocessor that performs communication via a shared local memory and an image processing system using the same.

In recent years, the high functionality and multi-functionality of a data processing device have been progressing and a multiprocessor system that operates a plurality of CPUs (Central Processing Unit) in parallel has been adopted in many cases. In such a multiprocessor system, as a connection form between processors, the shared bus connection, point-to-point connection, connection by crossbar switch, connection by ring bus, or the like are adopted.

The shared bus connection is a connection form in which a plurality of processors connected to a shared bus performs parallel processing while sharing data. One of the examples is a shared memory type multiprocessor system in which processors are connected by a shared memory. To avoid access competition, a bus controller arbitrates a bus. When access competition is generated, the processor needs to wait until the bus is released.

The point-to-point connection is developed as a successor of the shared bus architecture and is a connection form for connecting chips and I/O hubs (chip set). In general, the transfer in the point-to-point connection is unidirectional. To perform bidirectional communication, it is necessary to use two differential data links. Then, the number of signal lines increases. It is possible to cope with the routing function and cache coherency protocol by a five-layer hierarchical architecture. The structure and control become very complicated.

Furthermore, the point-to-point connection adopting the packet transfer scheme is also developed. This connection, which is fast and flexible, has multiple functions such as the function to cope with data transfer using DDR (Double Data Rate), the function to automatically adjust the transfer frequency, and the function to automatically adjust the bit width in accordance with the data width of 2 to 32. But, the configuration of the connection becomes very complicated.

The connection by crossbar switch is a many-to-many connection form and it is possible to flexibly select a data transfer path and exhibit high performance. However, as the number of objects to be connected to increases, the circuit scale increases sharply.

In the connection by ring bus, CPUs are connected by a bus in a ring and it is possible to deliver data between neighboring CPUs. When a four-system ring bus is used, the two systems are used for clockwise data transfer and the two remaining systems are used for counterclockwise data transfer. With the connection by ring bus, the circuit scale may be small, the configuration is simple, and extension is easy. However, the delay time at the time of data transfer is large and not suitable to improve performance.

As technologies relating to the above, there are inventions disclosed in Japanese Patent Laid-Open No. 1990-199574 (Patent Document 1) and U.S. Pat. No. 7,617,363 (Patent Document 2) and technology disclosed in D. Pham et al., “The Design and Implementation of a First-Generation CELL Processor,” 2005 IEEE International Solid-State Circuits Conference (ISSCC 2005), Digest of Technical Papers, pp. 184-185, February 2005 (Non-Patent Document 1).

Patent Document 1 relates to a multiprocessor system using a bus transfer path in which microprocessor systems and memories are arranged alternately in an annular transfer path including a unidirectional bus transfer path and a procedure signal path is provided between two microprocessor systems sharing one memory.

Patent Document 2 relates to a low latency message passing mechanism and discloses the point-to-point connection.

Non-Patent Document 1 relates to the first-generation CELL processor and discloses the ring bus connection.

### SUMMARY

In a shared memory type symmetrical multi-processor (SMP), the concentration of access to the shared memory causes a bottleneck. It is very difficult to improve the multiprocessor performance in a scalable manner in proportion to the number of processors.

Furthermore, in the parallel processing by the shared memory type SMP, spin lock processing for synchronous control and exclusive control between processes, processing such as bus snooping for maintaining cache coherency, or the like are indispensable. The increase in the waiting time associated with the processing and the reduction in performance associated with the increase in bus traffic contribute to impeding the improvement of the performance of the multiprocessor.

In contrast, in function-distributed processing by an as etrical multi-processor (AMP), it is possible to efficiently perform data processing by dividing the whole processing into several parts and causing each different processor to perform each part. However, the conventional shared bus type AMP has a problem in which it is difficult to improve performance because the concentration of bus access on the shared memory causes a bottleneck as in the case of SMP.

The point-to-point connection, connection by crossbar switch, and connection by ring bus have the above-mentioned problems.

The present invention has been made to solve the above-mentioned problems and provides a multiprocessor capable of eliminating the bottleneck by concentration of bus access and capable of improving the scalability of the parallel processing performance, and an image processing system using the same.

According to an embodiment of the present invention, a multiprocessor is provided. The multiprocessor includes a plurality of processor units, a plurality of cache memories provided corresponding to the respective processor units, an I/F for connecting a shared memory connected to the cache memories via a shared bus and accessed by the processor units, and a plurality of shared local memories. Each of the shared local memories is connected to two processors of the processor units.

According to an embodiment of the present invention, each of the shared local memories is connected to two processors of the processor units. It becomes possible to easily share data and buffer data to be transferred.

### BRIEF DESCRIPTION OF THE DRAWINGS

FIG. 1 is a diagram showing a configuration of a general shared memory type multiprocessor system.

FIG. 2 is a block diagram showing a configuration of a multiprocessor in a first embodiment of the present invention.

FIG. 3 is a diagram showing a conceptual configuration of the multiprocessor in the first embodiment of the present invention.

FIG. 4 is a diagram showing a semiconductor device including the multiprocessor in the first embodiment of the present invention.

FIG. 5 is a diagram showing a configuration of a multiprocessor when a 1-port memory is used as a shared local memory.

FIG. 6 is a diagram showing a configuration of a multiprocessor when a 2-port memory is used as a shared local memory.

FIG. 7 is a diagram showing a semaphore register.

FIG. 8 is a flowchart showing exclusive control using the semaphore register in FIG. 7.

FIG. 9 is a diagram showing an arrangement of a processor unit and a shared local memory on a semiconductor chip.

FIG. 10 is a diagram showing an arrangement of four processor units.

FIG. 11 is a diagram showing a modification of configuration of processor units.

FIG. 12 is a diagram showing another bus connection form of the multiprocessor in the first embodiment of the present invention.

FIG. 13 is a diagram showing an address map of each processor unit in the bus connection form in FIG. 12.

FIG. 14 is a diagram showing a configuration when the multiprocessor in the first embodiment of the present invention is applied to an image processing system.

FIG. 15 is a block diagram showing a configuration of a multiprocessor in a second embodiment of the present invention.

FIG. 16 is a block diagram showing another configuration of the multiprocessor in the second embodiment of the present invention.

### DETAILED DESCRIPTION

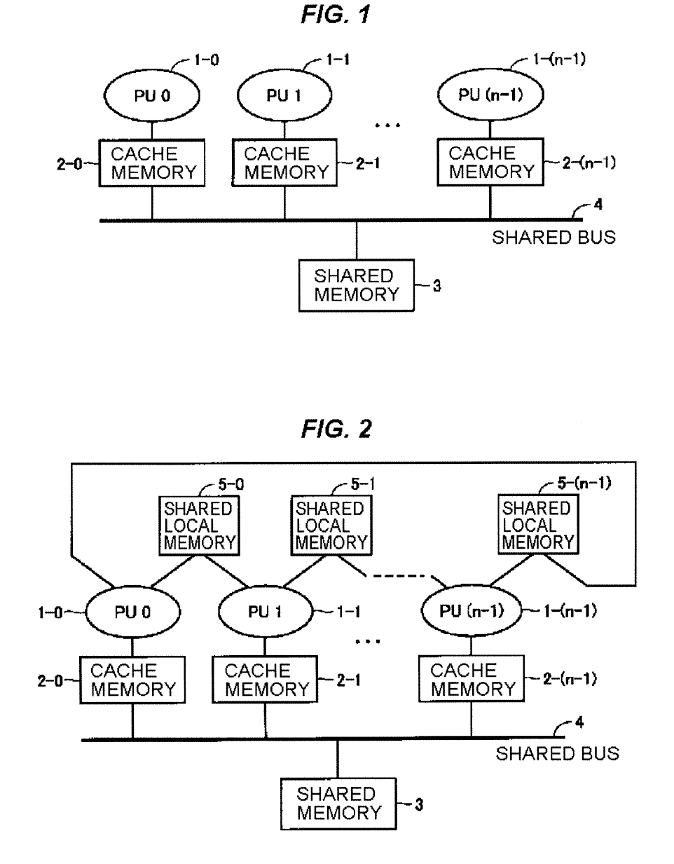

FIG. 1 is a diagram showing a configuration example of a general shared memory type multiprocessor system. The multiprocessor system includes n processor units PU 0 (1-0) to PU (n−1) (1-(n−1)), cache memories 2-0 to 2-(n−1) connected to the respective processor units, and a shared memory 3. It is possible for PU 0 to PU (n−1) (1-0 to 1-(n−1)) to access the shared memory 3 via the cache memories 2-0 to 2-(n−1) and a shared bus 4. The shared memory 3 includes a secondary cache memory and a main memory.

The development of the semiconductor process technology has allowed to integrate a number of processors over a semiconductor chip. In the configuration of the general shared bus type multiprocessor in FIG. 1, bus access causes a bottleneck. Then, it becomes difficult to improve performance in a scalable manner in accordance with the number of processors.

To improve the processing performance in a scalable manner in accordance with the number of processors, distribution of the function for each processor and parallel processing by pipeline processing with large granularity are effective. By dividing data processing into several processing stages, causing each of the processors to perform each stage of processing, and performing processing of data by the bucket brigade method, it is possible to process data at a high speed.

### First Embodiment

FIG. 2 is a block diagram showing a configuration of a multiprocessor in a first embodiment of the present invention. The multiprocessor includes the n processor units PU 0 (1-0) to PU (n−1) (1-(n−1)), the cache memories 2-0 to 2-(n−1) connected to the respective processor units, the shared memory 3, and n shared local memories 5-0 to 5-(n−1). It is possible for the PU 0 to PU (n−1) (1-0 to 1-(n−1)) to access the shared memory 3 via the cache memories 2-0 to 2-(n−1) and the shared bus 4.

Each of the shared local memories 5-0 to 5-(n−1) is connected to the two neighboring processor units. The shared local memory 5-0 is connected to the PU 0 (1-0) and PU 1 (1-1). Similarly, the shared local memory 5-1 is connected to the PU 1 (1-1) and PU 2 (1-2). The shared local memory 5-(n−1) is connected to the PU (n−1) (1-(n−1)) and PU 0 (1-0). As shown in FIG. 2, the PU 0 (1-0) to PU (n−1) (1-(n−1)) and the shared local memories 5-0 to 5-(n−1) are connected in a ring.

In this manner, between the two neighboring processor units, a communication path using a shared local memory is provided. In the configuration, a dedicated data path is provided to allow one of the neighboring processor units to access the local memory possessed by the other processor unit and the local memory is shared between the neighboring processor units.

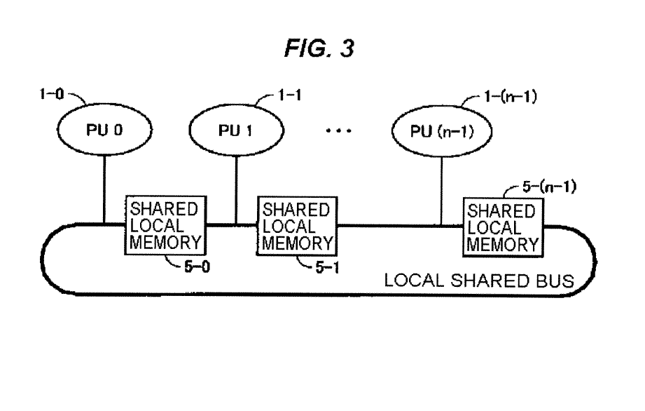

FIG. 3 is a diagram showing a conceptual configuration of the multiprocessor in the first embodiment of the present invention. In the multiprocessor in the present embodiment, the processors are connected in the point-to-point manner using the shared local memories 5-0 to 5-(n−1), the shared local memory is arranged between the processor units, and data is transferred between the neighboring processor units via the shared local memory. Conceptually, this operates as a ring bus connection in which the shared local memory is arranged between all the neighboring processors as shown in FIG. 3. Because the processor units are connected by using the shared local memories 5-0 to 5-(n−1)), the data transfer direction is not restricted and it is possible to perform bidirectional data transfer.

It is possible to arrange both program code and data in the shared local memories 5-0 to 5-(n−1). While executing the program code over the corresponding shared local memory, the processor unit does not perform an instruction fetch to the shared bus 4. Furthermore, when all the operand data necessary for data processing is in the shared local memory, it is unnecessary for the processor unit to read the operand data from the shared memory 3 via the shared bus 4.

As described above, the processor unit can process data without accessing the shared memory 3 connected to the shared bus 4 of the system by using the shared local memory as a local instruction memory and data memory.

Furthermore, because the processor unit is symmetric and the start point or the end point is not determined, it is possible to immediately process the next data based on the previous data processing result and it is unnecessary to write back the interim result of data to the shared memory.

Moreover, because the PU 0 to PU (n−1) (1-0 to 1-(n−1)) take partial share of the contents of processing and perform function-distributed processing using the corresponding shared local memories 5-0 to 5-(n−1), it is possible to avoid the bus bottleneck of the shared bus 4 and it becomes possible to perform parallel processing at a high speed in a scalable manner.

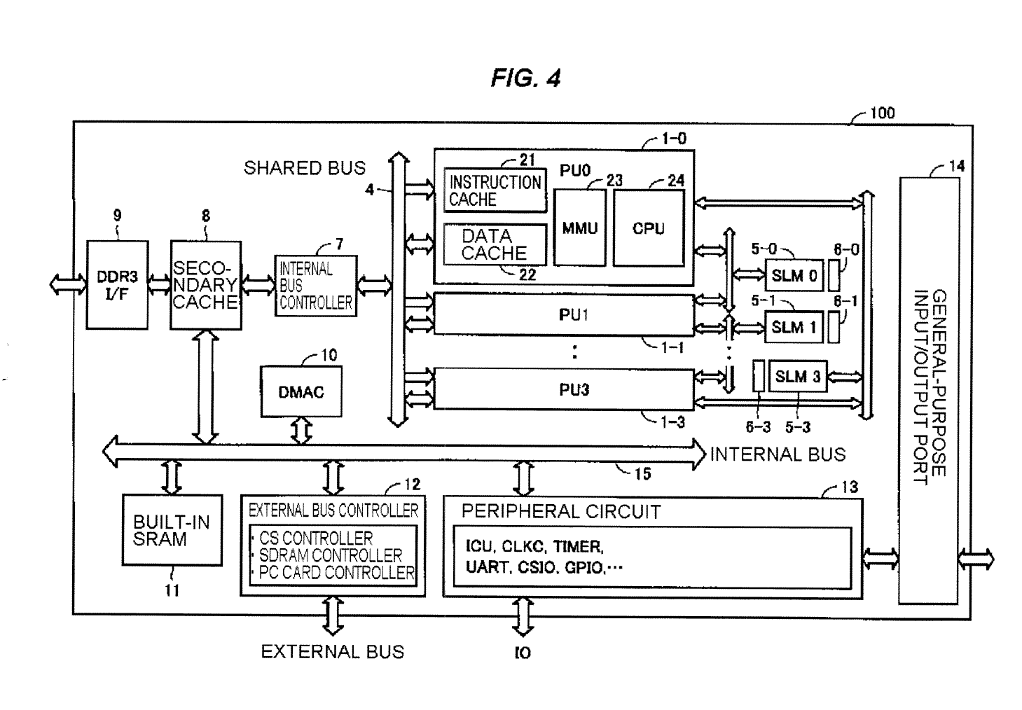

FIG. 4 is a diagram showing a semiconductor device including the multiprocessor in the first embodiment of the present invention. A semiconductor device 100 includes the PU 0 to 3 (1-0 to 1-3), shared local memories (SLM) 0 to 3 (5-0 to 5-3), exclusive control synchronization mechanisms 6-0 to 6-3 provided corresponding to the SLMs 0 to 3 (5-0 to 5-3), an internal bus controller 7, a secondary cache 8, a DDR 3 I/F 9, a DMAC (Direct Memory Access Controller) 10, a built-in SRAM 11, an external bus controller 12, a peripheral circuit 13, and a general-purpose input/output port 14. FIG. 4 describes the four processor units (PU) and the four shared local memories (SLM), but the numbers of these PUs and SLMs are not limited to four.

The internal bus controller 7 is connected to the PUs 0 to 3 (1-0 to 1-3) via the shared bus 4 and accesses the secondary cache 8 in response to an access request from the PUs 0 to 3 (1-0 to 1-3).

When an access is requested from the internal bus controller 7 and the secondary cache 8 retains the instruction code or data, the secondary cache 8 outputs the code or data to the internal bus controller 7. When not retaining the instruction code or data, the secondary cache 8 accesses the DMAC 10 and the built-in SRAM 11 which are connected to the internal bus 15, an external memory connected to the external bus controller 12, the peripheral circuit 13, an external memory connected to the DDR 3 I/F 9 or the like.

The DDR 3 I/F 9 is connected to an SDRAM (Synchronous Dynamic Random Access Memory (SDRAM) located outside the semiconductor device 100, which is not shown, and controls the access to the SDRAM.

In response to a request from the PUs 0 to 3 (1-0 to 1-3), the DMAC 10 controls the DMA transfer between memories or between memory and I/O.

The external bus controller 12 includes a CS controller, SDRAM controller, and PC card controller. It controls the access to SDRAM or a memory card outside the semiconductor device 100.

The peripheral circuit 13 includes an ICU (Interrupt Control Unit), CLKC (Clock Controller), TIMER (timer), UART (Universal Asynchronous Receiver-Transmitter), CSIO (Clocked Serial Input Output), and GPIO (General Purpose Input Output).

The general-purpose input/output port 14 is connected to a peripheral device, which is not shown and located outside the semiconductor device 100. It controls the access to the peripheral device.

In addition, the PU 0 (1-0) includes an instruction cache 21, a data cache 22, an MMU (Memory Management Unit) 23, and a CPU 24. The PUs 1 to 3 (1-1 to 1-3) have the same configuration.

When the CPU 24 fetches an instruction code or accesses data, the MMU 23 examines whether or not the instruction cache 21 or the data cache 22 retains the instruction code or data. When the instruction code or data is retained, the MMU 23 fetches the instruction code from the instruction cache 21, reads the data from the data cache 22, or writes the data to the data cache 22.

In addition, when neither the instruction code nor the data is retained, the MMU 23 accesses the secondary cache 8 via the internal bus controller 7. Furthermore, when the CPU 24 accesses the SLM 0 (5-0) or SLM 3 (5-3), the MMU 23 accesses it directly.

The SLMs 0 to 3 (5-0 to 5-3) include a fast memory such as a small-scale SRAM. When the PUs 0 to 3 (1-0 to 1-3) execute a large-scale program, it is possible to eliminate the restriction on the program size by fetching the program code from the main memory, such as SDRAM located outside the semiconductor device 100, via the instruction cache 21, not by placing the program code in the SLMs 0 to 3 (5-0 to 5-3).

FIG. 5 is a diagram showing a configuration of a multiprocessor when a 1-port memory is used as a shared local memory. An SLM i (5-i) is connected to a PU i (1-i) and PU j (1-j) via the local shared bus. An SLM j (5-j) is connected to the PU j (1-j) and PU k (1-k) via the local shared bus.

An SEM i (6-i) is a synchronization mechanism (semaphore) that performs exclusive control of the access from the PU (1-i) and PU j (1-j) to the SLM i (5-i). Similarly, an SEM j (6-j) is a synchronization mechanism that performs exclusive control of the access from the PU j (1-j) and PU k (1-k) to the SLM j (5-j).

Compared with a 2-port memory, the 1-port memory has a small memory cell area and is more highly integrated. It is possible to realize a fast shared local memory having a comparatively large capacity. When the 1-port memory is used, the arbitration of access to the shared local memory is necessary.

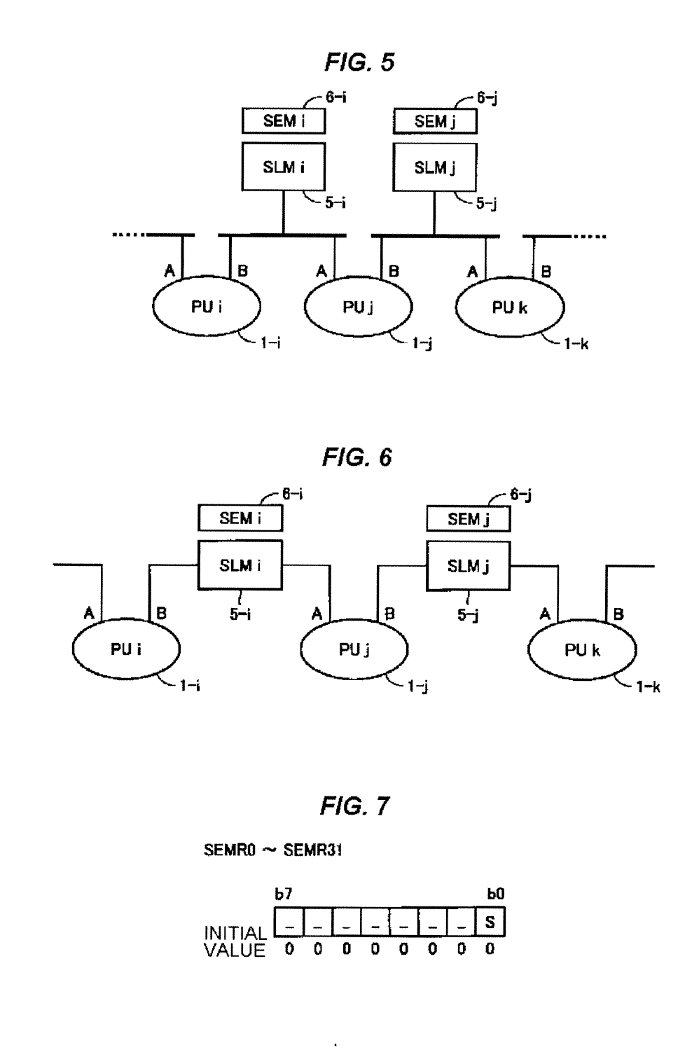

FIG. 6 is a diagram showing a configuration of a multiprocessor when a 2-port memory is used as a shared local memory. Each port of the SLM i (5-i) is connected to the PU i (1-i) and PU j (1-j). Each port of the SLM j (5-j) is connected to the PU j (1-j) and PU k (1-k).

The SEM (6-i) is a synchronization mechanism (semaphore) that performs exclusive control of the access from the PU i (1-i) and PU j (1-j) to the SLM i (5-i). Similarly, the SEM j (6-j) is a synchronization mechanism that performs exclusive control of the access from the PU j (1-j) and PU k (1-k) to the SLM j (5-j).

When the 2-port memory is used, the memory cell area is large. It is difficult to realize a shared local memory having a large capacity, but it is possible to read data from the two ports at the same time. Arbitration to the read access is unnecessary. When the 2-port memory is used, exclusive control of write processing is also necessary to guarantee the consistency of data.

As shown in FIGS. 5 and 6, each processor unit has a port for point-to-point connection between the neighboring processor units and the shared local memory is connected to these ports. The port of each processor unit to the processor unit next on the left is referred to as “port A” and the port to the processor unit next on the right is referred to as “port B”

As described later, each of the shared local memories connected to the ports of the processor unit is memory-mapped to an operand accessible space from each processor unit and arranged in an address region uniquely specified by the port name.

It is possible to realize exclusive control for synchronization of programs by software by using an exclusive control instruction of the processor. It is also possible to realize exclusive control of the resource by using the synchronization mechanism of hardware.

In the multiprocessor in FIGS. 5 and 6, the shared memory is caused to have a semaphore flag realized by hardware as such a synchronization mechanism. By mapping the flag bit of the hardware semaphore to a memory map as a control register of a peripheral IO, it is possible to easily realize exclusive control by the access from the program.

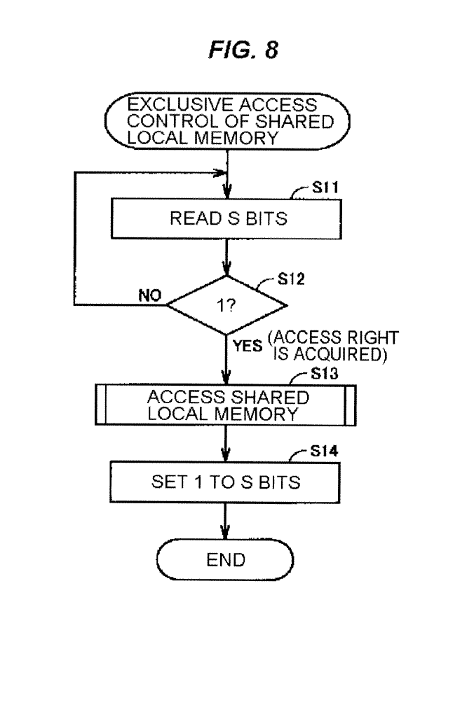

FIG. 7 is a diagram showing a semaphore register. In FIG. 7, 32 SEMS are provided and S bits readable/writable are mapped as a semaphore flag. In the S bits, a written value is retained. When the processor unit reads the contents, the value is automatically cleared after the reading.

The S bits of the semaphore register indicate the access prohibited state when they are set to 0 and the access permitted state when they are set to 1. When exclusive control is preformed by the semaphore register, it is necessary to initialize the S bits to 1 indicating the access permitted state in advance by programs.

By using one of such semaphore registers for each shared resource, it is possible to perform exclusive access control of the whole shared local memory or a partial region by programs.

FIG. 8 is a flowchart showing exclusive control using the semaphore register in FIG. 7. First, the processor unit reads the contents of the semaphore register of the corresponding shared local memory (S11) and determines whether or not the values of the S bits are set to 1 indicating the access permitted state (S12). When the values of the S bits are not set to 1 (S12, No), the operation to read the S bits is repeated again and stays in standby until the access is permitted.

At this time, it may be possible for the processor unit to simply read the S bits by polling. It may also be possible for the processor unit to stay in standby for a predetermined period of time before reading again or to process another task during standby.

When the values of the S bits are set to 1 indicating the access permitted state (S12, Yes), the processor unit acquires the access right to the shared resource and accesses the shared local memory (S13). When completing the access to the share local memory, the processor unit sets 1 to the S bits of the semaphore register to permit access to another processor unit by releasing the access right, and exits the exclusive access control.

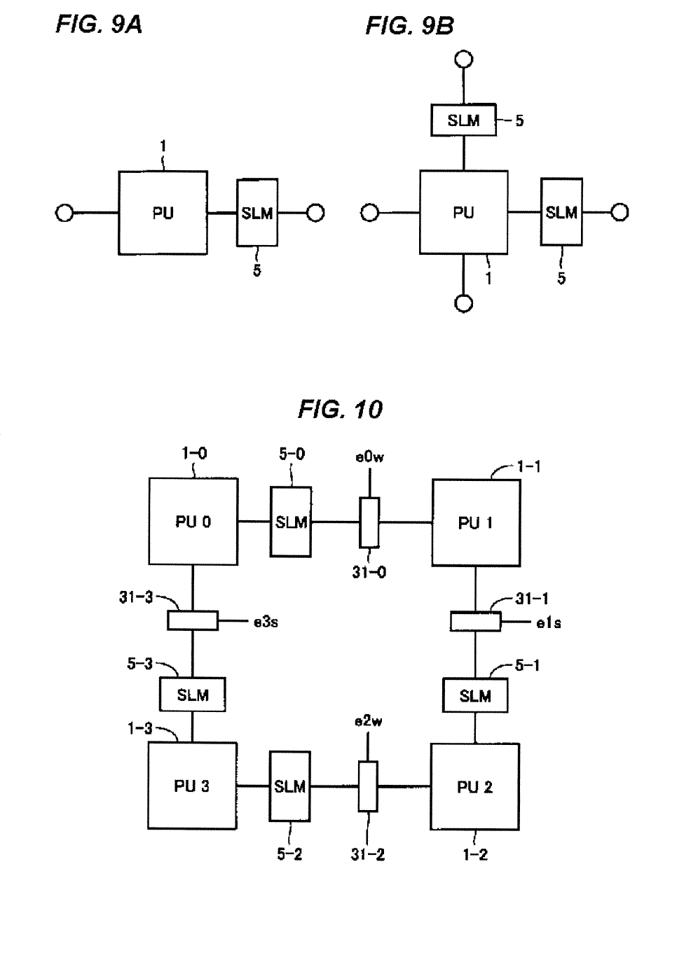

FIG. 9 is a diagram showing an arrangement of the processor unit and the shared local memory over the semiconductor chip. FIG. 9(a) shows a 2-port connection of the processor unit. FIG. 9(b) shows a 4-port connection of the processor unit. As shown in FIGS. 9(a) and 9(b), the processor unit and the shared local memory are adjacent to each other. It is possible to shorten the wire between the processor unit and the shared local memory shortest as much as possible and to efficiently arrange the data transfer path between the processor units.

FIG. 10 is a diagram showing an arrangement of the four processor units. When the four PUs 0 to 3 (1-0 to 1-3) are arranged symmetrically, it is possible to implement the arrangement by the processor units of the 2-port connection in FIG. 8(a). Between the processor units, switches 31-0 to 31-3 are connected to dynamically switch the connections of the ports and the shared local memories.

By controlling enable signals e0w, e1s, e2w, and e3s of the switches 31-0 to 31-3, it becomes possible to dynamically enable/disable the point-to-point connection between the neighboring processor units.

When more processor units are arranged in two dimensions, it is possible to regularly arrange the processor units and the shared local memories by combining the processor unit of the 4-port connection in FIG. 9(b) and that of the 2-port connection in FIG. 9(a).

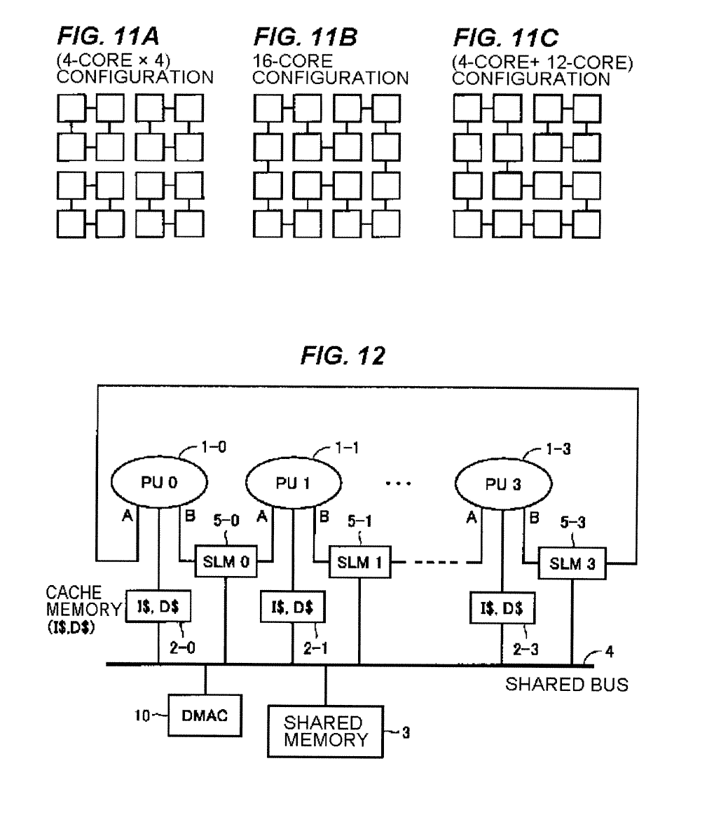

FIG. 11 is a diagram showing a modification of configuration of processor units. FIG. 11 shows arrangements in which 16 processor units of the 4-port connection in FIG. 9(b) are arranged in a matrix. By switching the switches arranged between each processor unit, it is possible to dynamically switch the connections between processor units and to freely modify the processor unit configuration.

FIG. 11(a) shows a configuration ((4-core×4) configuration) having four groups of domains in which four processor units are connected. The configuration is suitable to process data with a comparably light processing load.

FIG. 11(b) shows a configuration (16-core configuration) in which 16 processor units are connected. The configuration is suitable to process data with a heavier processing load. FIG. 11(c) shows a configuration (4-core+12-core) configuration) having a configuration in which four processor units are connected and a configuration in which 12 processor units are connected. The configuration can appropriately modify the connections of processor units in accordance with the processing load.

Moreover, when the load of the system is light, it is possible to considerably reduce the power consumption of the system, excluding a domain including a part of processor units, by stopping the clocks of and shutting down the power sources of other domains.

As described later, by mapping the shared local memory from the processor unit to an accessible memory space, it is possible to freely access the shared local memory from the processor unit. In addition, by mapping the control register for controlling the enable signal of the switch that switches the point-to-point connections, it becomes possible to dynamically switch the connections between processor units by programs.

The method of changing the connection between processor units includes (1) a method in which all the switches can be switched from specific or all the processors and (2) a method in which each processor unit switches only the switches near the processor unit.

In the method (1), the control register that controls the enable signals of all the switches is mapped from the processor unit to the accessible space so that the connections between any processor units can be switched by the switch, and then, the connection form of all theprocessor units is modified at a time from one processor unit. Although it becomes difficult to perform wiring within the semiconductor chip when the number of processor units increases, the programs are simple and it is possible to reduce the time required to switch the switches.

In the method (2), the control register that controls the enable signal of the switch is mapped only to a space locally accessible by each processor unit, and then, each processor unit modifies the connection form between processor units locally by switching the switches near the processor unit. It is necessary for each processor unit to execute programs to modify the connection form. Although the programs are complicated and time is required to modify the connection form, it is easy to perform wiring of the enable signal even if the number of processors increases, and the construction of a large-scale system is easy.

FIG. 12 is a diagram showing another bus connection form of the multiprocessor in the first embodiment of the present invention. The difference from the connection form of the multiprocessor in FIG. 2 is that the SLM 0 to SLM 3 (5-0 to 5-3) are also connected to the shared bus 4 and it is possible to access the shared local memory from a processor unit other than the processor unit neighboring the shared local memory. In FIG. 12, the instruction cache and the data cache are represented together as cache memories (I$, D$) 2-0 to 2-3.

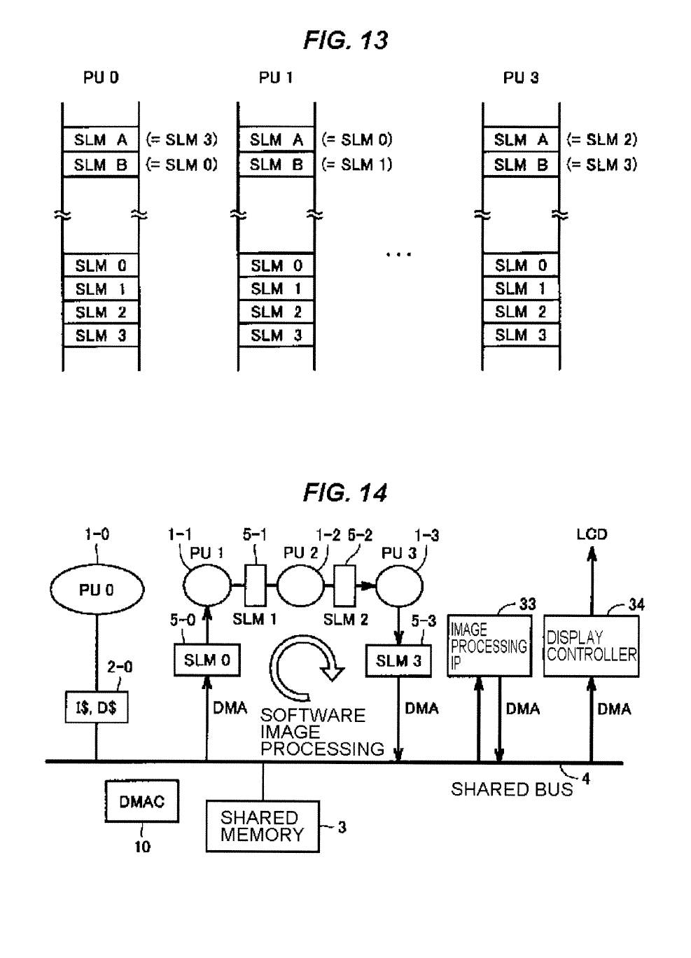

FIG. 13 is a diagram showing an address map of each processor unit in the bus connection form in FIG. 12. In each processor unit, the shared local memory corresponding to each port of the processor unit is mapped to the same address space. In the memory map of the PU 0 (1-0), the SLM 3 (5-3) is mapped to an SLM A area and the SLM 0 (5-0) is mapped to an SLM B area.

Consequently, a user can perform programming by focusing his/her attention only on the port to be connected without considering the number of the physical shared local memory.

In the memory map of each processor unit in FIG. 13, in accordance with the ID number of the shared local memory, all the shared local memories (SLM 0 to SLM 3) are mapped to the memory space accessible from the side of the shared bus 4. By mapping in this manner, the following merits are obtained.

First, it is possible for the processor unit to easily write the execution program to the shared local memory not adjacent to the processor unit and perform the initial setting of data processing. When the PU 0 (1-0) is used as a master processor, it becomes possible to easily start data processing after the PU 0 (1-0) writes the instruction code to the shared local memory connected to another processor unit by executing the program.

Furthermore, it becomes possible for the DMAC 10 to perform DMA transfer to each shared local memory via the shared bus 4. When the PU 0 (1-0) is a master processor, it is possible for the PU 0 (1-0) to control DAM transfer to each shared local memory by software. By using the exclusive control synchronization mechanism (semaphore) in FIGS. 5 and 6 for the enable control of DMA transfer, it is also possible to perform DMA transfer by hardware control.

When the master processor monitors the contents of the shared local memory, it is possible to observe the contents of data processing on the way of execution and to easily debug the program.

When the shared local memory is accessible from the side of the shared bus 4, too, it is possible to conduct a memory test by programs even if a test cannot be conducted in the scan path circuit, such as after mounting the semiconductor device on the board.

It is desirable to permit access to the shared memory from the side of the shared bus 4 only when the processor unit is in the supervisor mode. The reason is to prevent the reduction in the safety of the program being executed and the occurrence of a security problem when the shared memory becomes accessible from a processor unit other than the neighboring processor unit.

FIG. 14 is a diagram showing a configuration when the multiprocessor in the first embodiment of the present invention is applied to an image processing system. This image processing system includes the PU 0 to PU 3 (1-0 to 1-3), the cache memory 2-0, the shared memory 3, the SLM 0 to SLM 3 (5-0 to 5-3), the DMAC 10, an image processor IP 33, and a display controller 34. The same reference numeral is attached to the part having the same configuration and function as that of the component of the multiprocessor in FIGS. 2 to 6.

The PU 1 to PU 3 (1-1 to 1-3) and the SLM 0 to SLM 3 (5-0 to 5-3) are connected in a ring. The SLM 0 (5-0) and the SLM 3 (5-3) are also connected to the shared bus 4.

The main processor PU 0 (1-0) is the master processor for system control and the PU 1 to PU 3 (1-1 to 1-3) are used as an image processor. Image data stored in the shared memory 3 is stored in the SLM 0 (5-0) by DMA transfer and then the PUs 1 to 3 (1-1 to 1-3) process the image data sequentially. The processed data is transferred between processor units via the SLM 1 (5-1) and the SLM 2 (5-2) and then the data is transferred to the shared memory 3, the image processor IP 33, or the like from the SLM 3 (5-3) by DMA transfer.

The image processor IP 33 receives image data from the shared memory 3 or the SLM 3 (5-3) by DMA transfer and performs image processing, such as image reduction, block noise reduction, and frame interpolation processing. Then, the data after being subjected to image processing is transferred to the shared memory 3 or the display controller 34 by DMA transfer.

By combining the software image processing by the PU 1 to PU 3 (1-1 to 1-3) and the hardware image processing by the image processor IP 33, it is process image data very flexibly and fast.

The display controller 34 receives image data to be displayed from the shared memory 3 or the image processor IP 33 by DMA transfer and displays the image data on a display unit such as an LCD (Liquid Crystal Display).

According to the multiprocessor in the present embodiment, each shared local memory is shared only by two neighboring processor units and data is transferred by point-to-point connection. Consequently, it is no longer necessary to synchronize detailed timing for data transfer between the processor unit on the transmission side and that on the reception side and it becomes possible to easily share data and buffer data to be transferred.

Because each shared local memory is shared only by two processor units, bus access is unlikely to cause a bottleneck. It becomes possible to aim to improve performance in a scalable manner in proportion to the number of processor units by distributing functions in the AMP configuration.

Because it becomes possible to dynamically switch the connection paths by the shared local memory, it is possible to dynamically set the number of processor units that can be used for data processing and it becomes possible to construct a multiprocessor configuration that provides necessary and sufficient processing performance. Furthermore, the clocks and the power sources of the group of unused processor units are stopped and cut off in accordance with the load conditions of the system. Then, it becomes possible to reduce power consumption.

Because the point-to-point connection via the shared local memory is used, it is possible to process data at a high speed while sharing data between neighboring processor units. By buffering transfer data in the shared memory, it becomes possible to process data at a high speed while sharing data between neighboring processor units even when the load is heavy in the processor on the reception side.

Furthermore, when the shared local memory is shared only between two processor units, it is impossible to access the shared local memory from another processor unit that is not adjacent to one of the two processor units. Consequently, it is possible to prevent destruction of data by an erroneous operation or unauthorized access and it becomes possible to increase safety and security of the programs of the system.

### Second Embodiment

In the first embodiment, the shared local memory is mounted in the shared memory type multiprocessor. A second embodiment of the present invention relates to a distributed memory type multiprocessor in which only the shared local memory, not the shared memory, is mounted.

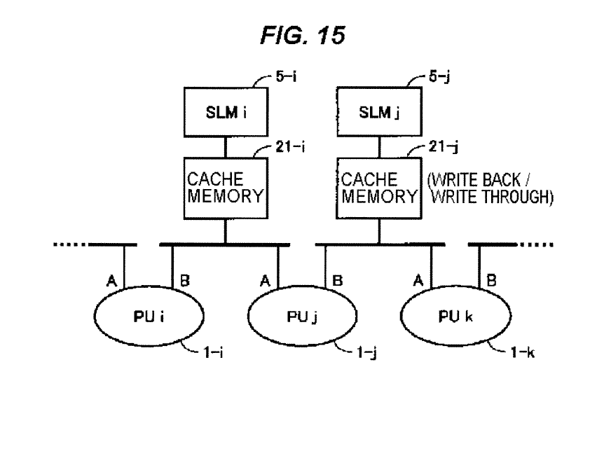

FIG. 15 is a block diagram showing a configuration of a multiprocessor in the second embodiment of the present invention. The multiprocessor includes PU i to PU k (1-i to 1-k), the SLM i and SLM j (5-i, 5-j), and cache memories 21-1 and 21-j. The SLM i and SLM j (5-i, 5-j) include a 1-port memory.

In the present embodiment, because no shared memory is mounted, the SLM i and SLM j (5-i, 5-j) need a comparatively large capacity. In general, a memory system with a large capacity is slow in speed. Thus, the cache memories 21-i and 21-j are provided to increase the execution speed.

Because the cache memories 21-i and 21-j are accessed after the arbitration of access to the shared local bus, it is possible to use the protocol of write back or that of write through.

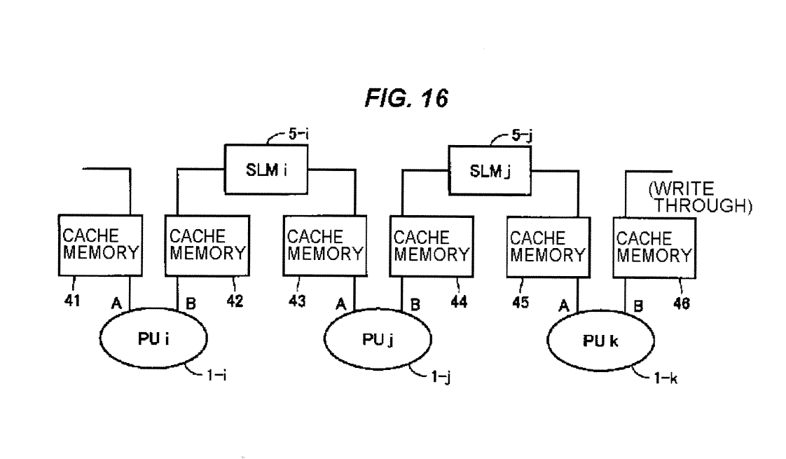

FIG. 16 is a block diagram showing another configuration of the multiprocessor in the second embodiment of the present invention. The processor includes the PU i to PU k (1-i to 1-k), the SLM i and SLM j (5-i, 5-j), and cache memories 41 to 46. The SLM i and SLM j (5-i, 5-j) include a 2-port memory.

Because the shared local memories 5-i and 5-j include a 2-port memory, the cache memories 41 to 46 are provided on the processor unit side. It is possible to adopt the cache coherency protocol, such as MESI, for these cache memories 41 to 46 to keep cache coherency. In the AMP type function distributed processing, it is possible to share data and perform exclusive control with small granularity. Thus, it becomes possible to improve performance during execution while the circuit scale and complication are regulated by adopting the write through type cache memory.

According to the multiprocessor in the present embodiment, no shared memory is mounted and only the shared local memory is mounted. Thus, it becomes possible to further distribute the bus access in addition to the effect explained in the first embodiment.

The disclosed embodiments should be considered to be illustrative only in every respect but not restrictive. The scope of the invention is indicated not by the descriptions but by the scope of the claims. The scope of the invention is intended to include the meaning equivalent to the claims and all the modifications within the scope of the inventions.

What is claimed is:

1. A multiprocessor comprising:
a plurality of processors;
a plurality of cache memories provided corresponding to each of the processors;
an interface unit connected to the cache memories via a shared bus and configured to connect a shared memory accessed from the processors; and
a plurality of shared local memories,
wherein each of the shared local memories is connected to two processors of the processors.

2. The multiprocessor according to claim 1, further comprising a plurality of controllers provided corresponding to each of the shared local memories and configured to control writing to and reading from two processors to be connected.

3. The multiprocessor according to claim 2,
wherein each of the shared local memories has an area to store a register storing information for permitting write and read, and
two processors connected to each of the shared local memories refer to the register and perform writing to and reading from the corresponding shared local memory.

4. The multiprocessor according to any of claims 1,
wherein the processors are arranged in a matrix,
the shared local memories are arranged between the processors,
the multiprocessor further includes a plurality of switching units configured to switch the connections between the processors and the shared local memories, and
the shared local memories have an area to store information for switching the switching units.

5. The multiprocessor according to claim 4,
wherein each of the processors stores information for switching the switching units corresponding to the shared local memory to be connected.

6. The multiprocessor according to claim 4,
wherein at least one of the processors stores information for switching all the switching units in the shared local memory to be connected.

7. A multiprocessor comprising:
a plurality of processors;
a plurality of shared local memories; and
a plurality of cache memories provided corresponding to the shared local memories and connected to two processors of the processors,
wherein the processors and the cache memories are connected in a ring.

8. A multiprocessor comprising:
a plurality of processors;
a plurality of shared local memories; and
a plurality of cache memories provided corresponding to each port of the processors and connected to the ports of the shared local memories,
wherein each of the shared local memories is connected to two cache memories of the cache memories.

9. An image processing system comprising:
a plurality of processors;
a plurality of cache memories provided corresponding to each of the processors;
an interface unit connected to the cache memories via a shared bus and configured to connect a shared memory accessed from the processors;
a plurality of shared local memories;
an image processing unit configured to perform image processing on image data processed by the processors; and
a display unit configured to display image data after being processed by the image processing unit,
wherein each of the shared local memories is connected to two processors of the processors,
and
the processors and the shared local memories are connected in a ring.
